(19) United States
(12) Patent Application Publication
(10) Pub. No.: US 2026/0205738 A1
(43) Pub. Date: Jul. 16, 2026

(54) SPEAKER

(71) Applicant: MERRY ELECTRONICS (SUZHOU) CO., LTD., Suzhou City (CN)

(72) Inventors: Jiawei ZHU, Suzhou City (CN); Mingya LUO, Suzhou City (CN)

(73) Assignee: MERRY ELECTRONICS (SUZHOU) CO., LTD., Suzhou City (CN)

(21) Appl. No.: 19/273,652

(22) Filed: Jul. 18, 2025

(30) Foreign Application Priority Data
Jan. 15, 2025 (CN) 202520096823.2

(51) Int. Cl. H04R 9/02; H04R 1/02; H04R 7/12; H04R 7/14; H04R 9/04; H04R 9/06

(52) U.S. Cl. CPC H04R 9/022; H04R 1/025; H04R 7/125; H04R 7/14; H04R 9/025; H04R 9/045; H04R 9/06

(57) ABSTRACT

A speaker includes a carrying bracket, a diaphragm, and a voice coil. The carrying bracket is provided with an accommodating cavity and a mounting opening. The accommodating cavity communicates with an exterior of the speaker through the mounting opening. A first heat dissipation layer is disposed on one end of the carrying bracket provided with the mounting opening. The diaphragm covers the mounting opening and is provided with a second heat dissipation layer. The second heat dissipation layer abuts against the first heat dissipation layer. The voice coil is connected to the second heat dissipation layer, extends into the accommodating cavity, and is spaced apart from an inner wall of the accommodating cavity.

### CROSS-REFERENCE TO RELATED APPLICATION(S)

This application claims priority to Chinese Patent Application No. 202520096823.2 filed Jan. 15, 2025, the disclosure of which is incorporated herein by reference in its entirety.

### TECHNICAL FIELD

The present disclosure relates to the field of speaker technology and, in particular, to a speaker.

### BACKGROUND

A speaker is a transducer device that converts electrical signals into acoustic signals. For a radiator, heat dissipation is an important parameter for evaluating the performance of a speaker.

At present, most speakers generally use exposing magnets or heat sink to dissipate heat. That is, the speakers dissipate heat efficiently by air convection between the magnets/heat sink and ambient air. However, heat dissipation is only limited to the exposed part of the speakers, failing to guarantee the efficient heat dissipation of internal components of the speakers and thus resulting in moderate effect and efficiency of heat dissipation.

### SUMMARY

The present disclosure provides a speaker to improve the effect and efficiency of heat dissipation of the speaker.

The present disclosure adopts the technical solutions described below.

A speaker is provided. The speaker includes a carrying bracket, a diaphragm, and a voice coil.

The carrying bracket is provided with an accommodating cavity and a mounting opening. The accommodating cavity communicates with an exterior of the speaker through the mounting opening. A first heat dissipation layer is disposed on one end of the carrying bracket provided with the mounting opening.

The diaphragm covers the mounting opening and is provided with a second heat dissipation layer. The second heat dissipation layer abuts against the first heat dissipation layer.

The voice coil is connected to the second heat dissipation layer, extends into the accommodating cavity, and is spaced apart from an inner wall of the accommodating cavity.

In some embodiments, the speaker further includes a magnetic circuit assembly. The magnetic circuit assembly is connected to the carrying bracket. The voice coil is configured to be disposed in a magnetic gap formed by the magnetic circuit assembly.

In some embodiments, the magnetic circuit assembly includes a yoke plate and a main magnetic member. The yoke plate is connected to the carrying bracket. A heat dissipation hole is formed between the yoke plate and the carrying bracket. The accommodating cavity communicates with an exterior of the speaker through the heat dissipation hole. The main magnetic member is connected to the yoke plate.

In some embodiments, a plurality of main magnetic members are provided. A heat dissipation path communicating with the heat dissipation hole is provided between the plurality of main magnetic members.

In some embodiments, the magnetic circuit assembly further includes an auxiliary magnetic member connected to the yoke plate. The voice coil is disposed between the main magnetic member and the auxiliary magnetic member.

In some embodiments, a plurality of auxiliary magnetic members are provided. The carrying bracket is provided with a plurality of heat dissipation openings. The accommodating cavity communicates with the exterior of the speaker through the plurality of heat dissipation openings. The plurality of auxiliary magnetic members engage with the plurality of heat dissipation openings in a one-to-one correspondence.

In some embodiments, the magnetic circuit assembly further includes a magnetic conduction plate. The magnetic conduction plate is disposed on the main magnetic member and/or the auxiliary magnetic member.

In some embodiments, the third heat dissipation layer is disposed on the yoke plate.

In some embodiments, one second heat dissipation layer is provided and is in an annular shape.

In some embodiments, a plurality of second heat dissipation layers are provided and are spaced apart sequentially in a circumferential direction of the voice coil.

In some embodiments, the diaphragm is provided with a folded portion. The folded portion is provided with the second heat dissipation layer.

### BRIEF DESCRIPTION OF DRAWINGS

FIG. 1 is a structural view of a speaker according to an embodiment of the present disclosure.

FIG. 2 is an axonometric view of the speaker according to the embodiment of the present disclosure.

FIG. 3 is a sectional view of the speaker according to the embodiment of the present disclosure.

FIG. 4 is a partial enlarged view of part A of FIG. 3.

FIG. 5 is a first exploded view of the speaker according to the embodiment of the present disclosure.

FIG. 6 is a second exploded view of the speaker according to the embodiment of the present disclosure.

FIG. 7 is a view illustrating that a diaphragm is connected to a carrying bracket according to the embodiment of the present disclosure.

FIG. 8 is a view of the diaphragm according to the embodiment of the present disclosure.

### DETAILED DESCRIPTION

The present disclosure is further described below in detail in conjunction with drawings and embodiments. It is to be understood that the specific embodiments set forth below are intended to merely illustrate and not to limit the present disclosure. In addition, it is to be noted that for ease of description, only part, not all, of structures related to the present disclosure are illustrated in the drawings.

In the description of the present disclosure, unless otherwise expressly specified and limited, the term “connected to each other”, “connected” or “secured” is to be construed in a broad sense, for example, as securely connected, detachably connected or integrated; mechanically connected or electrically connected; directly connected to each other or indirectly connected to each other via an intermediary; or internally connected between two elements or interaction relations between two elements. For those of ordinary skill in the art, specific meanings of the preceding terms in the present disclosure may be understood based on specific situations.

In the present disclosure, unless otherwise expressly specified and limited, when a first feature is described as being “on” or “below” a second feature, the first feature and the second feature may be in direct contact or be in contact via another feature between the two features instead of being in direct contact. Moreover, when the first feature is described as being “on”, “above” or “over” the second feature, the first feature is right on, above or over the second feature, the first feature is obliquely on, above or over the second feature, or the first feature is simply at a higher level than the second feature. When the first feature is described as being “under”, “below” or “underneath” the second feature, the first feature is right under, below or underneath the second feature, the first feature is obliquely under, below or underneath the second feature, or the first feature is simply at a lower level than the second feature.

In the description of the embodiments, it is to be noted that orientations or position relations indicated by terms such as “above”, “below” and “right” are based on the drawings. These orientations or position relations are intended only to facilitate the description and simplify an operation and not to indicate or imply that a device or element referred to must have such particular orientations or must be configured or operated in such particular orientations. Thus, these orientations or position relations are not to be construed as limiting the present disclosure. In addition, the terms “first” and “second” are used only for distinguishing between descriptions and have no special meaning.

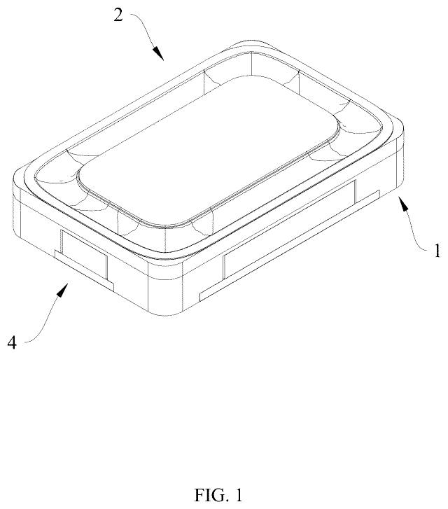

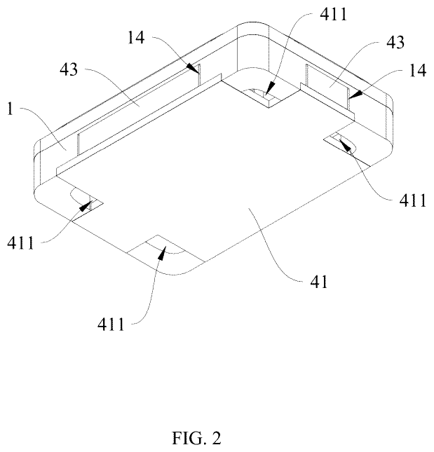

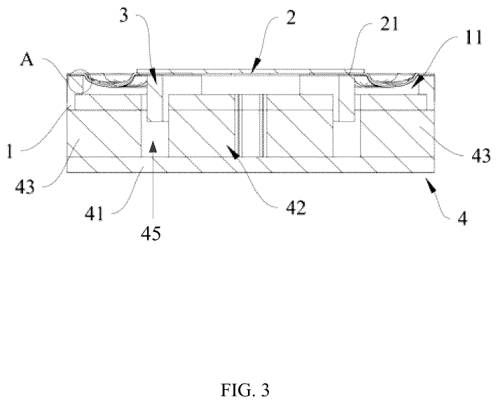

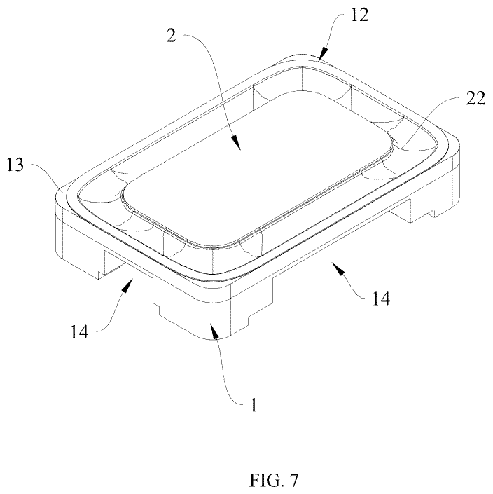

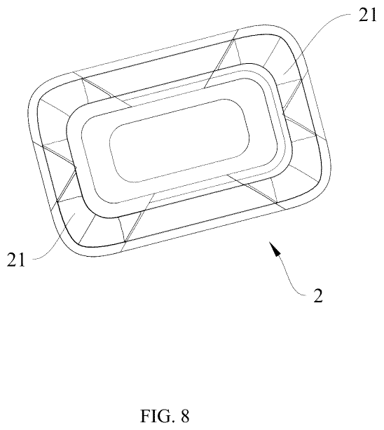

As shown in FIGS. 1 to 8, this embodiment provides a speaker including a carrying bracket 1, a diaphragm 2, and a voice coil 3. The carrying bracket 1 is provided with an accommodating cavity 11 and a mounting opening 12. The accommodating cavity 11 communicates with the exterior of the speaker through the mounting opening 12. A first heat dissipation layer 13 is disposed on one end of the carrying bracket 1 provided with the mounting opening 12. The diaphragm 2 covers the mounting opening 12 and is provided with a second heat dissipation layer 21. The second heat dissipation layer 21 abuts against the first heat dissipation layer 13. The voice coil 3 is connected to the second heat dissipation layer 21, extends into the accommodating cavity 11, and is spaced apart from an inner wall of the accommodating cavity 11.

In this embodiment, the carrying bracket 1 is provided with the accommodating cavity 11 and the mounting opening 12. The accommodating cavity communicates with the exterior of the speaker through the mounting opening 11, facilitating the assembly of the speaker and providing space for heat dissipation of elements in the accommodating cavity 11. The first heat dissipation layer 13 is disposed on one end of the carrying bracket 1 provided with the mounting opening 12. The diaphragm 2 covers the mounting opening 12 so that the diaphragm 2 transfers the heat generated by the vibration of the diaphragm 2 to the exterior of the speaker through the first heat dissipation layer 13, thereby improving the effect and efficiency of heat dissipation. The diaphragm 2 is provided with the second heat dissipation layer 21. The second heat dissipation layer 21 abuts against the first heat dissipation layer 13, improving the efficiency of heat dissipation. The voice coil 3 is connected to the second heat dissipation layer 21, guaranteeing that the heat generated by the voice coil 3 in the working process can be rapidly dissipated through the second heat dissipation layer 21. The voice coil 3 extends into the accommodating cavity 11 and is spaced apart from the inner wall of the accommodating cavity 11, guaranteeing sufficient heat dissipation space between the voice coil 3 and the carrying bracket 1, avoiding friction caused by direct contact of the voice coil 3 with the inner wall of the accommodating cavity 11, and improving the stability and durability of the speaker. Through the preceding arrangement, the effect and efficiency of heat dissipation of the speaker in this embodiment can be improved.

The specific structure of the speaker is described hereinafter.

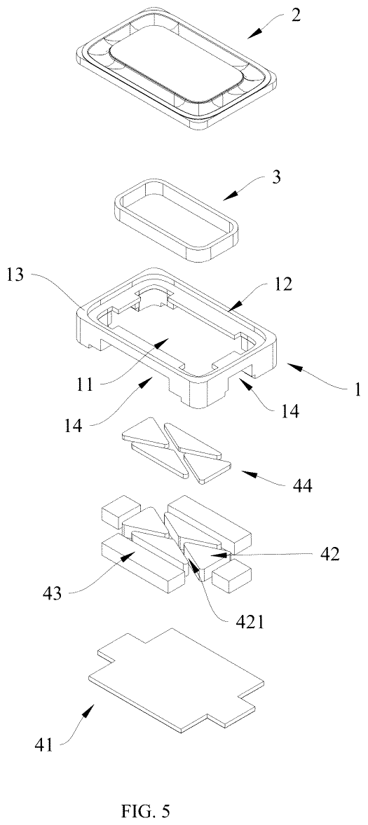

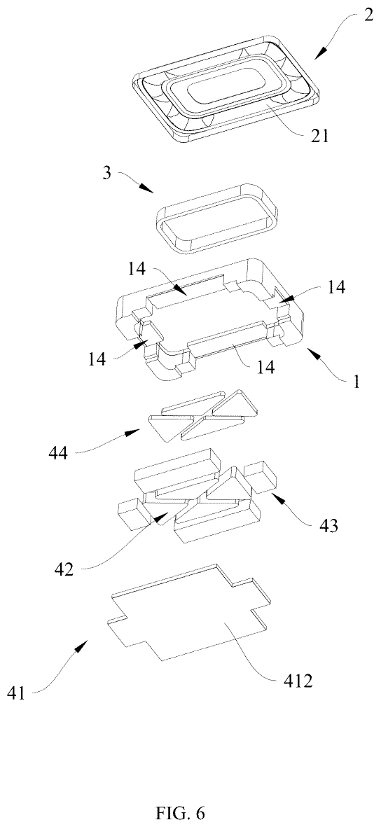

In some embodiments, as shown in FIGS. 5 and 6, the carrying bracket 1 includes a bracket and a supporting plate. The accommodating cavity 11 penetrates through the bracket to facilitate the assembly and connection with other components. The supporting plate surrounds the inner wall of the accommodating cavity 11 and is provided with a plurality of stop protrusions. The voice coil 3 is disposed between the stop protrusions so as to facilitate the assembly of the voice coil 3.

In some embodiments, as shown in FIGS. 1 to 8, the overall structure of the diaphragm 2 of this embodiment is plate-shaped, improving the utilization rate of the structure space. In other embodiments, the diaphragm 2 is dome-shaped. That is, as long as the preceding functions can be implemented, the specific structure of the diaphragm 2 is not limited here.

In some embodiments, the diaphragm 2 is provided with a folded portion 22. The folded portion 22 is provided with the second heat dissipation layer 21. The folded portion 22 includes folded rings and patterns, thereby increasing the contact area between the diaphragm 2 and the air and thus improving the efficiency of heat dissipation.

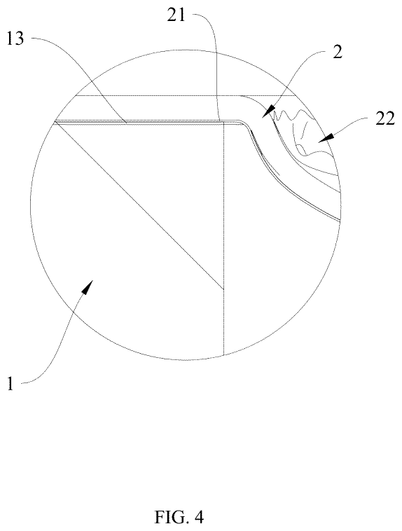

In some embodiments, as shown in FIGS. 4, 6, and 7, one second heat dissipation layer 21 is provided and arranged in an annular shape, thereby increasing the contact area between the second heat dissipation layer 21 and the first heat dissipation layer 13, providing a more uniform effect of heat dissipation, effectively transferring the heat generated by the diaphragm 2 to the carrying bracket 1, and implementing further heat dissipation through air convection. As shown in FIGS. 5 to 8, alternatively, a plurality of second heat dissipation layers 21 are provided and spaced apart sequentially in the circumferential direction of the voice coil 3. The second heat dissipation layers 21 abut against the first heat dissipation layer 13, controlling the heat dissipation region more precisely, improving the efficiency of heat dissipation, reducing the accumulation of heat inside the second heat dissipation layers 21, and improving the uniformity of heat dissipation. It is to be noted that those skilled in the art can adjust the arrangement manner of the second heat dissipation layers 21 according to the specific shape and size of the voice coil 3 so as to adapt to the heat dissipation requirements of different speakers. No excessive description is made here.

In some embodiments, as shown in FIGS. 1 to 6, the speaker further includes a magnetic circuit assembly 4. The magnetic circuit assembly 4 is connected to the carrying bracket 1. The voice coil 3 is configured to be disposed in a magnetic gap 45 formed by the magnetic circuit assembly 4, guaranteeing that the voice coil 3 can stably vibrate under the magnetic force of the magnetic circuit assembly 4.

In some embodiments, the magnetic circuit assembly 4 includes a yoke plate 41. The yoke plate 41 is connected to the carrying bracket 1. Heat dissipation holes 411 are formed between the yoke plate 41 and the carrying bracket 1. The accommodating cavity 11 communicates with the exterior of the speaker through the heat dissipation holes 411 so that elements inside the accommodating cavity 11 dissipate heat timely through the heat dissipation holes 411, thereby further improving the effect of heat dissipation of the speaker. A plurality of heat dissipation holes 411 are provided to improve the efficiency of heat dissipation of the speaker.

In some embodiments, the yoke plate 41 is a cross-shaped plate. That is, the overall structure of the yoke plate 41 is “cross-shaped”. The yoke plate 41 is sequentially provided with a plurality of connection protrusions along the circumferential direction of the yoke plate 41. Connection recesses engaging with the connection protrusions are disposed on one end of the carrying bracket 1 facing away from the mounting opening 12. The engagement of the connection protrusions with the connection recesses improves the connection strength and stability between the yoke plate 41 and the carrying bracket 1. In other embodiments, the connection recesses are disposed on the yoke plate 41. The connection protrusions are disposed on the carrying bracket 1. That is, as long as the preceding functions can be implemented, the specific positions of the preceding components are not limited here.

In some embodiments, the magnetic circuit assembly 4 further includes main magnetic members 42 connected to the yoke plate 41. In some embodiments, a plurality of main magnetic members 42 are provided. A heat dissipation path 421 communicating with the heat dissipation holes 411 is provided between the main magnetic members 42 so that the heat generated by the speaker can be dissipated to the exterior of the speaker more rapidly through the heat dissipation holes 411 and the heat dissipation path 421, thereby further improving the heat dissipation capacity of the speaker.

In some embodiments, four main magnetic members 42 are provided and are each a triangular prism. The heat dissipation path 421 provided between the four main magnetic members 42 is entirely “X”-shaped. The “X”-shaped heat dissipation path 421 enables space to be utilized more effectively, increasing the heat dissipation area and contributing to the uniform distribution and rapid dissipation of heat.

In some embodiments, the magnetic circuit assembly 4 further includes auxiliary magnetic members 43 connected to the yoke plate 41. The voice coil 3 is disposed between the main magnetic members 42 and the auxiliary magnetic members 43, guaranteeing that the voice coil 3 can stably vibrate under the magnetic force of the main magnetic members 42 and the auxiliary magnetic members 43. Moreover, the arrangement of the main magnetic members 42 and the auxiliary magnetic members 43 optimizes the distribution of magnetic field lines, thereby improving the efficiency of magnetic energy conversion.

In some embodiments, in this embodiment, the main magnetic members 42 and the auxiliary magnetic members 43 are magnetic blocks and are generally made of high-performance rare-earth magnet materials, such as neodymium iron boron magnets. The main magnetic members 42 are used for providing a strong magnetic field. The auxiliary magnetic members 43 are used for assisting the main magnetic members 42 to enhance the strength of the magnetic field and make the vibration of the voice coil 3 in the magnetic field more stable.

In some embodiments, four auxiliary magnetic members 43 are provided and are each a cuboid. The four auxiliary magnetic members 43 are spaced apart on the yoke plate 41 and surround the main magnetic members 42, enhancing the strength of the magnetic field of the main magnetic members 42 and making the distribution of the magnetic field more uniform. In other embodiments, six or eight main magnetic members 42 and six or eight auxiliary magnetic members 43 may be provided and be each a cylinder. That is, as long as the preceding functions can be implemented, the specific number and structural shape of the preceding components are not limited here.

In some embodiments, a plurality of auxiliary magnetic members 43 are provided for assisting the main magnetic members 42 and optimizing the distribution of magnetic field lines. The carrying bracket 1 is provided with a plurality of heat dissipation openings 14. The accommodating cavity 11 communicates with the exterior of the speaker through the heat dissipation openings 14 so that the heat in the accommodating cavity 11 is dissipated to the exterior of the speaker more rapidly through the heat dissipation openings 14. The auxiliary magnetic members 43 engage with the heat dissipation openings 14 in a one-to-one correspondence, facilitating the assembly of the auxiliary magnetic members 43 and the carrying bracket 1, reducing operation difficulty, and improving the efficiency of heat dissipation of the speaker.

It is to be noted that the arrangement of a plurality of main magnetic members 42 and a plurality of auxiliary magnetic members 43 increases the contact area between the magnetic circuit assembly 4 and the air, improves the effect of heat dissipation, and facilitates the flow of the air inside the accommodating cavity 11, thereby increasing the heat convection coefficient and enabling the magnetic circuit assembly 4 to absorb heat and dissipate heat outward more rapidly.

In some embodiments, the magnetic circuit assembly 4 further includes magnetic conduction plates 44. A magnetic conduction plate 44 is disposed on a main magnetic member 42 and/or an auxiliary magnetic member 43, enhancing the performance of the magnetic circuit assembly 4. Moreover, the magnetic conduction plate 44 is shaped to conform to the main magnetic member 42 and/or the auxiliary magnetic member 43, facilitating the assembly and connection of the magnetic conduction plate 44 with the main magnetic member 42 and/or the auxiliary magnetic member 43, and guaranteeing the uniform distribution of the magnetic field. The magnetic conduction plate 44 is generally made of a material having high magnetic conductivity, such as an alloy material like iron, nickel, or cobalt, and is disposed on the main magnetic member 42 and/or the auxiliary magnetic member 43 by bonding or screwing. The specific material and connection manner of the magnetic conduction plate 44 are not limited here as long as the preceding functions can be implemented.

In some embodiments, as shown in FIG. 6, a third heat dissipation layer 412 is disposed on the yoke plate 41, increasing the heat exchange area between the yoke plate 41 and the external environment and thereby improving the efficiency of heat dissipation.

It is to be noted that as shown in FIGS. 1 to 8, in this embodiment, the voice coil 3 is a heat source. The voice coil 3 can diffuse heat into the accommodating cavity 11 in the form of heat radiation, thereby implementing heat dissipation through the heat dissipation path 421, the heat dissipation holes 411, and the heat dissipation openings 14.

In some embodiments, the first heat dissipation layer 13, the second heat dissipation layer 21, and the third heat dissipation layer 412 are processed in a spraying process. Further, a heat dissipation thin layer with the thickness of 1 um to 100 um, a high thermal conductivity coefficient, and high radiance is formed, guaranteeing the effect of heat dissipation and facilitating space saving and cost control. The first heat dissipation layer 13, the second heat dissipation layer 21, and the third heat dissipation layer 412 may also be disposed on corresponding components in modes like gluing, which is not limited here. Additionally, the specific thickness of the heat dissipation thin layer needs to be appropriate. An excessively small thickness may cause poor heat dissipation, while an excessively large thickness may cause the diaphragm 2 to break due to excessive stress during vibration. Therefore, the thickness of the heat dissipation thin layer needs to be adjusted according to different sizes of the diaphragm 2. The specific thickness of the diaphragm 2 is not excessively described here.

In some embodiments, the heat of the voice coil 3 is transferred to the diaphragm 2 and the carrying bracket 1 sequentially through the heat dissipation thin layer and then is dissipated to the exterior of the speaker via air convection through the first heat dissipation layer 13 on the carrying bracket 1. To guarantee that the heat dissipation thin layer has a sound effect of heat dissipation, the thermal conductivity coefficient and radiance of the material used in the heat dissipation thin layer need to be relatively high, while the Young's modulus needs to be relatively low. It is to be understood that the heat dissipation thin layer in this embodiment includes silver nanowire, carbon ink, and resin adhesive. Because the silver nanowire has high thermal conductivity, the heat dissipation thin layer can reduce the working temperature of the speaker, thereby improving the stability and service life of the speaker. The black appearance and high radiance of the carbon ink increase the heat absorption and radiation ability of the heat dissipation thin layer, thereby further improving the efficiency of heat dissipation. With sound adhesive performance and durability, the resin adhesive can firmly bond the silver nanowire and the carbon ink together, thereby forming the stable and durable heat dissipation thin layer. In other embodiments, each of the first heat dissipation layer 13, the second heat dissipation layer 21, and the third heat dissipation layer 412 includes, but is not limited to, one or more of a thermally conductive silica gel, a thermally conductive graphite sheet, an aluminum alloy, or a copper alloy. As long as the preceding functions can be implemented, the specific material of the preceding heat dissipation thin layer is not limited here.

What is claimed is:

1. A speaker, comprising:
a carrying bracket provided with an accommodating cavity and a mounting opening, wherein a first heat dissipation layer is disposed on one end of the carrying bracket provided with the mounting opening;
a diaphragm covering the mounting opening and provided with a second heat dissipation layer, wherein the second heat dissipation layer abuts against the first heat dissipation layer; and
a voice coil connected to the second heat dissipation layer, extending into the accommodating cavity, and spaced apart from an inner wall of the accommodating cavity.

2. The speaker according to claim 1, further comprising a magnetic circuit assembly, wherein the magnetic circuit assembly is connected to the carrying bracket, and the voice coil is configured to be disposed in a magnetic gap formed by the magnetic circuit assembly.

3. The speaker according to claim 2, wherein the magnetic circuit assembly comprises a yoke plate and a main magnetic member, the yoke plate is connected to the carrying bracket, a heat dissipation hole is formed between the yoke plate and the carrying bracket, the heat dissipation hole communicates with an exterior of the speaker, and the main magnetic member is connected to the yoke plate.

4. The speaker according to claim 3, wherein a plurality of main magnetic members are provided, and a heat dissipation path communicating with the heat dissipation hole is provided between the plurality of main magnetic members.

5. The speaker according to claim 3, wherein the magnetic circuit assembly further comprises an auxiliary magnetic member connected to the yoke plate, and the voice coil is disposed between the main magnetic member and the auxiliary magnetic member.

6. The speaker according to claim 5, wherein a plurality of auxiliary magnetic members are provided, the carrying bracket is provided with a plurality of heat dissipation openings, the accommodating cavity communicates with the exterior of the speaker through the plurality of heat dissipation openings, and the plurality of auxiliary magnetic members engage with the plurality of heat dissipation openings in a one-to-one correspondence.

7. The speaker according to claim 5, wherein the magnetic circuit assembly further comprises a magnetic conduction plate, and the magnetic conduction plate is disposed on the main magnetic member.

8. The speaker according to claim 5, wherein the magnetic circuit assembly further comprises a magnetic conduction plate, and the magnetic conduction plate is disposed on the auxiliary magnetic member.

9. The speaker according to claim 5, wherein the magnetic circuit assembly further comprises magnetic conduction plates, and the magnetic conduction plates are disposed on the main magnetic member and the auxiliary magnetic member.

10. The speaker according to claim 4, wherein the magnetic circuit assembly further comprises an auxiliary magnetic member connected to the yoke plate, and the voice coil is disposed between the plurality of main magnetic members and the auxiliary magnetic member.

11. The speaker according to claim 10, wherein a plurality of auxiliary magnetic members are provided, the carrying bracket is provided with a plurality of heat dissipation openings, the accommodating cavity communicates with the exterior of the speaker through the plurality of heat dissipation openings, and the plurality of auxiliary magnetic members engage with the plurality of heat dissipation openings in a one-to-one correspondence.

12. The speaker according to claim 10, wherein the magnetic circuit assembly further comprises magnetic conduction plates, and the magnetic conduction plates are disposed on the plurality of main magnetic members, respectively.

13. The speaker according to claim 10, wherein the magnetic circuit assembly further comprises a magnetic conduction plate, and the magnetic conduction plate is disposed on the auxiliary magnetic member.

14. The speaker according to claim 10, wherein the magnetic circuit assembly further comprises magnetic conduction plates, and the magnetic conduction plates are disposed on the plurality of main magnetic members and the auxiliary magnetic member, respectively.

15. The speaker according to claim 3, wherein a third heat dissipation layer is disposed on the yoke plate.

16. The speaker according to claim 1, wherein one second heat dissipation layer is provided and is in an annular shape.

17. The speaker according to claim 1, wherein a plurality of second heat dissipation layers are provided and are spaced apart sequentially in a circumferential direction of the voice coil.

18. The speaker according to claim 1, wherein the diaphragm is provided with a folded portion, and the folded portion is provided with the second heat dissipation layer.

19. The speaker according to claim 6, wherein the magnetic circuit assembly further comprises magnetic conduction plates, and the magnetic conduction plates are disposed on the main magnetic member and the plurality of auxiliary magnetic members, respectively.

20. The speaker according to claim 11, wherein the magnetic circuit assembly further comprises magnetic conduction plates, and the magnetic conduction plates are disposed on the plurality of main magnetic members and the plurality of auxiliary magnetic members, respectively.
